(19) United States
(12) Patent Application Publication
(10) Pub. No.: US 2024/0404807 A1
(43) Pub. Date: Dec. 5, 2024

(54) SYSTEMS AND METHODS FOR SIGNAL DECONVOLUTION FOR NON-CONTACT SAMPLE EJECTION

(71) Applicant: DH Technologies Development Pte. Ltd., Singapore (SG)

(72) Inventors: Gordana IVOSEV, Etobicoke (CA); Chang LIU, Richmond Hill (CA)

(73) Assignee: DH Technologies Development Pte. Ltd., Singapore (SG)

(21) Appl. No.: 18/694,178

(22) PCT Filed: Sep. 23, 2022
(86) PCT No.: PCT/IB2022/059054

§ 371 Date: Mar. 21, 2024

Related U.S. Application Data
(60) Provisional application No. 63/247,344, filed on Sep. 23, 2021.

(51) Int. Cl. H01J 49/00; H01J 49/04

(52) U.S. Cl. CPC H01J 49/0027; H01J 49/0404

(57) ABSTRACT

A method for determining a convolved peak intensity in a sample trace includes ejecting a plurality of sample ejections from a sample well plate. An ejection time log is generated which includes an ejection time of each of the plurality of sample ejections from the sample well plate. The plurality of sample ejections is analyzed with a mass analyzer. The sample trace of intensity versus time values is produced for the plurality of sample ejections based on the analysis. A known peak shape is obtained. A convolved peak intensity is determined for a convolved peak of the sample trace based at least in part on the known peak shape and the ejection time log.

### CROSS-REFERENCE TO RELATED APPLICATION

This application is being filed on Sep. 23, 2022, as a PCT International Patent Application that claims priority to and the benefit of U.S. Provisional Application No. 63/247,344, filed on Sep. 23, 2021, which application is hereby incorporated by reference in its entirety.

### BACKGROUND

Acoustic Ejection Mass Spectrometry (AEMS) is a high-throughput analytical platform, where nano-liter sized sample droplets are ejected acoustically from a sample well plate in a non-contact manner, and captured in an open port interface (OPI). The sample is diluted and transferred from the OPI to a mass spectrometer (MS) for analysis. Each ejection typically generates a 1 second baseline wide peak on the standard system setup, which determines the analytical throughput to ˜1 Hz. Although the 1 Hz speed has been significantly faster than the routine liquid chromatography-MS or flow-injection-MS, there are needs for even faster throughput for some assays. One way to improve the speed is to enable the sharper peak width, with the use of the lower viscosity carrier solvent (e.g. acetonitrile), significant higher nebulizer gas flowrate, and/or the significant hardware modification. These changes may not be able to be used for a wide range of assays in a robust way.

### SUMMARY

In one aspect, the technology relates to a method for determining a convolved peak intensity in a sample trace, the method including: ejecting a plurality of sample ejections from a sample well plate; generating an ejection time log including an ejection time of each of the plurality of sample ejections from the sample well plate; analyzing the plurality of sample ejections with a mass analyzer; producing the sample trace of intensity versus time values for the plurality of sample ejections based on the analysis; obtaining a known peak shape; and determining a convolved peak intensity for a convolved peak of the sample trace based at least in part on the known peak shape and the ejection time log. In an example, the method further includes estimating a position along the sample trace of the convolved peak. In another example, the method further includes estimating a peak shape of the convolved peak based at least in part on the known peak shape. In yet another example, the trace of intensity versus time includes a plurality of peaks and wherein the known peak shape is based at least in part on a shape of a subset of the plurality of peaks. In still another example, the method further includes obtaining pre-run sample data, wherein the pre-run sample data includes a pre-run sample trace, wherein the known peak shape is based at least in part on the pre-run sample trace.

In another example of the above aspect, the method further includes fitting at least one distribution function to the trace, wherein the fitted at least one distribution function includes the known peak shape. In an example, the at least one distribution function includes at least two distribution functions. In another example, the at least two distribution functions are different. In yet another example, the at least two distribution functions includes a Gaussian distribution function and a Weibull distribution function. In still another example, the method further includes detecting a separated peak shape at least one of before and after ejecting the plurality of sample ejections, wherein the known peak shape is based at least in part on the separated peak shape.

In another example of the above aspect, the convolved peak intensity is based at least in part on at least one of a peak area, a peak height, and a peak width. In an example, the convolved peak intensity is based at least in part on a predetermined percentage of the peak height. In another example, the convolved peak intensity includes a peak full-width half-maximum. In yet another example, the known peak shape is based at least in part on a chemical property of a sample in the sample well plate. In still another example, the known peak shape is modeled based at least in part on a transport liquid flow rate, a transfer conduit geometry, an open port interface geometry, and a transport liquid property. In another example of the above aspect, the method further includes modeling the known peak shape.

In another aspect, the technology relates to a mass analyzer including: a non-contact sample ejector; a sample receiver adjacent the non-contact sample ejector; a mass analysis device fluidically coupled to the sample receiver; a processor operatively coupled to the non-contact sample ejector, the sample receiver, and the mass analysis device; and memory coupled to the processor, the memory storing instructions that, when executed by the processor, perform a set of operations including: ejecting, with the non-contact sample ejector, a plurality of sample ejections from a sample well plate into the sample receiver; generating an ejection time log includes an ejection time of each of the plurality of sample ejections from the sample well plate; analyzing the plurality of sample ejections with the mass analysis device; producing a sample trace of intensity versus time values for the plurality of sample ejections based on the analysis; obtaining a known peak shape; and determining a convolved peak intensity for a convolved peak of the sample trace based at least in part on the known peak shape and the ejection time log. In an example, the mass analyzer further includes an ionization element, and wherein the set of operations further includes ionizing the plurality of sample ejections towards the mass analysis device. In another example, the mass analysis device includes at least one of a differential mobility spectrometer (DMS), a mass spectrometer (MS), and a DMS/MS. In yet another example, the non-contact sample ejector includes an acoustic droplet ejector. In still another example, the sample receiver includes an open port interface.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2 is a schematic diagram of a system for determining an intensity of a convolved peak using high-throughput sample introduction coupled MS.

FIG. 3 depicts a plot of deconvoluted peaks associated with a plurality of ejections, as well as a merged signal generated by a mass analysis device.

FIG. 4 depicts a plot of intensity for each ejection depicted in FIG. 3.

FIG. 5 depicts a method of determining a convolved peak intensity in a sample trace.

FIGS. 6A-6B depict examples of methods to obtain a known peak shape.

FIG. 7 is a plot of a first example of the method of FIG. 5, showing how an AEMS peak area calculation is improved by using the ejection timing data and using at least two different distribution functions.

FIGS. 8A-8B depict sample traces at 1 Hz sampling rate and 3 Hz sampling rate, respectively.

FIG. 9 depicts an example of a suitable operating environment in which one or more of the present examples can be implemented.

### DETAILED DESCRIPTION

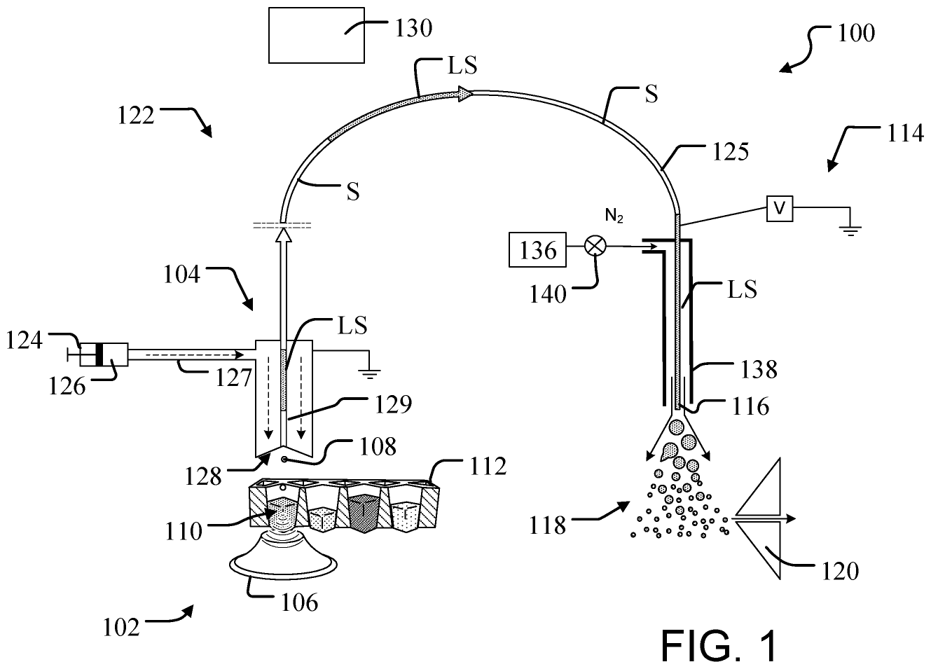

For illustrative purposes, FIG. 1 is a schematic view of an example system 100 combining an ADE 102 with an OPI sampling interface 104 and an ESI source 114, along with a mass spectrometer (MS). Such a system 100 may be referred to as an acoustic ejection mass spectrometer (AEMS). The system 100 may be a mass analysis instrument such as a MS device that is for ionizing and mass analyzing analytes received within an open end of the sampling OPI. Such a system 100 is described, for example, in U.S. Pat. No. 10,770,277, the disclosure of which is incorporated by reference herein in its entirety. The ADE 102 includes an acoustic ejector 106 that is configured to eject a droplet 108 from a reservoir of a well plate 112 into the open end of sampling OPI 104. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer nozzle 138 and electrospray electrode 116 of the ESI source 114, samples ejected therefrom are transformed into the gas phase. A liquid handling system 122 (e.g., including one or more pumps 124 and one or more transfer conduits 125) provides for the flow of liquid from a solvent reservoir 126 to the sampling OPI 104 and from the sampling OPI 104 to the ESI source 114. As ESI source 114 allows for the formation of multiple charged ions and are, therefore, more applicable to a variety of applications, they are described within the application for consistency. The technologies described herein, however, may also be utilized for systems that incorporate a plurality of atmospheric pressure chemical ionization (APCI) sources.

Returning to FIG. 1, the solvent reservoir 126 (e.g., containing a liquid transport solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPI 104 occurs within a sample space accessible at the open end such that one or more droplets 108 can be introduced into the liquid boundary 128 at the sample tip and subsequently delivered to the ESI source 114.

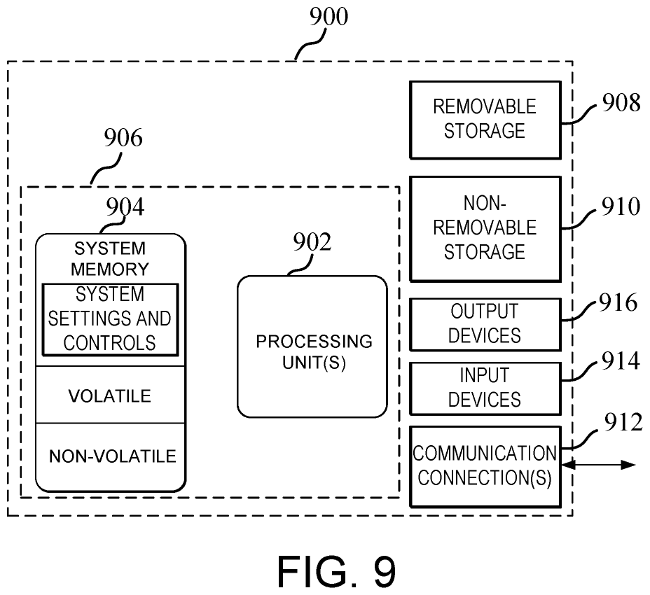

The system 100 includes an ADE 102 that is configured to generate acoustic energy that is applied to a liquid contained within a reservoir 110 that causes one or more droplets 108 to be ejected from the reservoir 110 into the open end of the sampling OPI 104. A controller 130 can be operatively coupled to and configured to operate any aspect of the system 100. This enables the acoustic transducer of the ADE 106 to inject droplets 108 into the sampling OPI 104 as otherwise discussed herein substantially continuously or for selected portions of an experimental protocol by way of non-limiting example. Other types of sample introduction systems, such as gravity-based droplet systems may be utilized. ADE 102 and other non-contact ejection systems are particularly advantageous, however, because of the high sample throughput that may be achieved. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art. An example of a controller is depicted in the context of FIG. 9.

As shown in FIG. 1, the ESI source 114 (when utilized) can include a source 136 of pressurized gas (e.g. nitrogen, air, or a noble gas) that supplies a high velocity nebulizing gas flow to the nebulizer nozzle 138 that surrounds the outlet tip of the electrospray electrode 116. As depicted, the electrospray electrode 116 protrudes from a distal end of the nebulizer nozzle 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of liquid sample (e.g., analyte-solvent dilution). The liquid discharged may include liquid samples LS received from each reservoir 110 of the well plate 112. The liquid samples LS are diluted with the solvent S and typically separated from other samples by volumes of the solvent S (hence, as flow of the solvent S moves the liquid samples LS from the OPI 104 to the ESI source 114, the solvent S may also be referred to herein as a transport liquid). The nebulizer gas can be supplied at a variety of flow rates, for example, in a range from about 0.1 L/min to about 40 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect/shock formation). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

The technologies described herein are used to deconvolve peaks in a sample trace generated by the system 100. In AEMS, MS signal peaks have a similar shape for a given assay under the same analytical conditions (e.g., carrier flow, analyte, ejection volume, and source condition). In addition, the relative constant delay time between the acoustic ejection event and the appearance of the MS signal enables prediction of the time when the ejection signal would occur. With the combined utilization of the predicted signal appearance timing and the peak-shape, the merged peaks may be deconvolved, allowing the determination of the intensity from each ejection even though the delay time between samplings are significantly shorter than the baseline peak-width. Intensity of the convolved peaks may be obtained via a number of methods, described below.

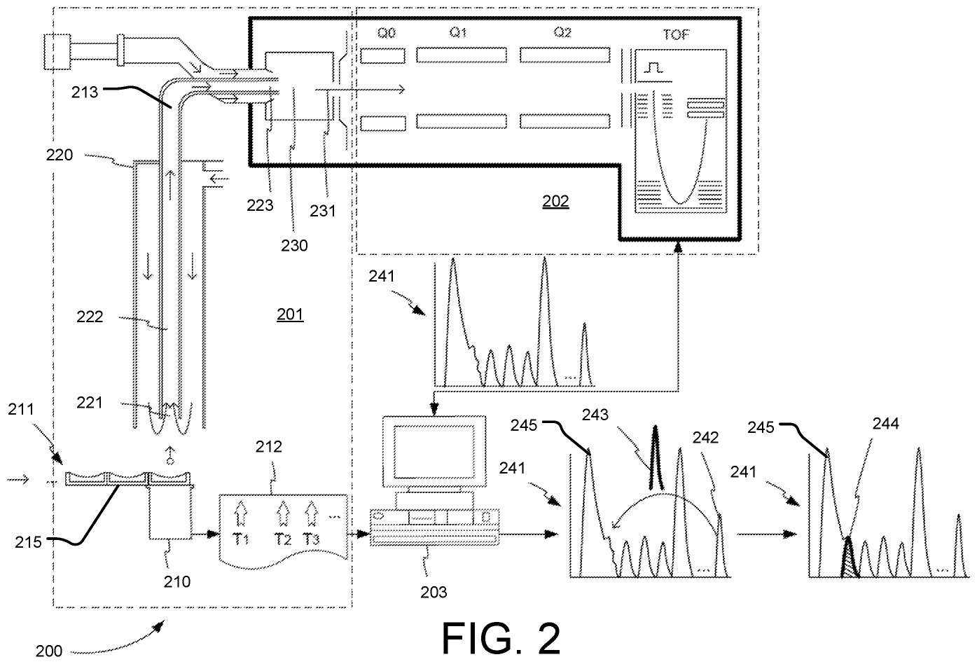

FIG. 2 is a system 200 for determining an intensity of a convolved sample peak of a trace produced using high-throughput sample introduction coupled mass spectrometry, in accordance with various embodiments. The system 200 includes a sample introduction system 201, MS 202, and processor 203. A number of the components of these systems are depicted in more detail in FIG. 1 and, as such, they are not necessarily described further. The sample introduction system 201 ejects each sample 211 from a well plate 215 at an ejection time. The ejected samples 211 may all be from a single well of the well plate 215, or from more than one well of a well plate 215. In other examples, each ejected samples 211 is a single sample 211 ejected from one or more wells of a well plate 215. A series of ejections times 212 corresponding to a series of ejected samples 211 is produced, for example, in the form of a data log. In examples, the sample introduction system 201 may ionize each ejected sample of series of samples 211, producing an ion beam 231. Such an ionization system is depicted in FIG. 1, above (e.g., including ESI source 114).

Mass spectrometer 202 receives the samples 211 (e.g., in the form of ion beam 231) and mass analyzes them over time. Each ejected sample 211 is not necessarily discretely received at the MS 202. In examples, the ejected samples 211 dilute and mix with the transport liquid as they travel along transfer conduit 213 and are sampled as they are received at the MS 202. A trace 241 of intensity versus time values for series of samples 211 is produced. In examples, the trace 241 of intensity versus time values may be for one or more m/z values for each sample 211.

Processor 203 (which may also be the system controller such as depicted in FIG. 1) receives trace 241 and the series of ejection times 212 (e.g., the ejection time log). In examples, the processor 203 determines a series of expected peak times corresponding to series of ejection times 212 using a known delay time from ejection to mass analysis. Depending on the transport liquid flow rate, transfer conduit 213 diameter, and other factors, the delay time may be between about 1 sec. and about 20 sec. Other delay times are contemplated. In examples, the processor 203 may identify at least one isolated or known peak 242 of trace 241 using the series of expected peak times. This known peak 242 may be used to determine one or more of a shape and an intensity of a convolved peak 244, which has effectively been subsumed by a larger adjacent peak 245. Thus, the known peak shape may be derived from a discrete, non-convolved, separate, or otherwise resolved peak that may be within the series of peaks of the trace 241. In other examples, the known peak shape may be an average of one or more peaks in the trace 241. Still other examples contemplate the known peak shape being determined from data obtained from a pre-run sample, which may be performed at a lower rate so as to more easily distinguish the peak shapes.

One or more distribution functions may also be utilized to determine the known peak shape; for example, the processor 203 may calculate a peak profile 243 by fitting a one or more distribution functions to at least one isolated peak 242. In some examples, the mixture of at least two different distribution functions is used to model an asymmetric peak. In such examples, the mixture of at least two different distribution functions produces an asymmetric peak that has a larger leading edge gradient than a trailing edge gradient. In examples, the at least two different distribution functions may be a Gaussian distribution function and a Weibull distribution function. In other examples, the mixture may be of one or more functions, for example, it could be mixture of Gaussian functions, or it could be mixture of Gaussian and Weibull functions, or it could be mixture of any number of different functions and any number of functions of each type. For example, three Gaussian functions, one Weibull function, and one exponentially modified Gaussian function may be utilized. Other mixtures are contemplated.

Peaks separate from the trace 241 may also be used to determine the known peak shape (e.g., test peaks used to identify the well plate or to otherwise indicate a condition or source of separate well plates). Further, a peak shape may be modeled based at least in part on a flow rate or property (e.g., viscosity) of the transport liquid or a geometry of the transfer conduit 213 or OPI 220. In another example, the known peak shape may be based in part on a chemical property of the ejected sample 211 from the sample well plate 215.

Finally, for at least one time of the series of the expected peak times, processor 203 may determine the intensity of the convolved peak 244. Methods to determine intensity are well-known in the art and include calculating an area of the convolved peak 244, which is based on the known peak shape. In FIG. 2, an area for only one convolved peak 244 of trace 241 may be calculated. In other examples, the area may be calculated for two or more peaks or for all peaks of trace 241. In other examples, intensity may be based on one or more of the peak height, peak width, and peak area. The intensity may be based on a pre-determined percentage of the peak height (e.g., about 1%, about 3%, about 5%, about 10%, about 25%, about 50%, about 60%, about 70%, about 75%, about 95%, about 97%, and about 99% of the peak height). Intensity based on peak full-width half-maximum (FWHM) may also be utilized.

In examples, processor 203 may identify one or more peaks that have a minimum overlap with adjacent peaks. This is done, for example, by calculating intensities at midpoints between peaks using the series of expected peak times obtained from the ejection time log (plus the known delay time due to sample transit). Thereafter, each peak that has an intensity at each midpoint with an adjacent peak that is less than a threshold intensity value is selected. The threshold intensity value may be a background intensity value or a fraction of the peak apex intensity. Finally, a peak of the one or more peaks that has a minimum overlap and that has the highest intensity is selected as at least one isolated peak 242. In examples, expected peak times are for a peak apex. Specifically, each time of the series of expected peak times includes a time at which an apex of a peak is expected.

The sample introduction system 201 need not be a droplet ejection system as described above. Instead, it may include a surface analysis system that can be, but is not limited to, a matrix-assisted laser desorption/ionization (MALDI) device or a laser diode thermal desorption (LDTD) device. FIG. 2 depicts a flow injection device and an ion source device. The flow injection device 210 may be a timed valve device that injects sample into a flowing stream at a particular sampling time through a valve at each ejection time of series of ejection times 212 and the ion source device ionizes samples of the flowing stream, producing ion beam 231. The flow injection device 210 can be a non-contact droplet dispenser such as an ADE to eject droplets into a flowing stream at each ejection time of the series of ejection times, and the ion source device ionizes samples of the flowing stream, producing ion beam 231.

In FIG. 2, the droplet dispenser is the ADE 210 that ejects series of samples 211 as droplets into inlet 221 of tube 222 of OPI 220. OPI 220 mixes the droplets of series of samples 211 with a transfer liquid in tube 222 to form a series of analyte-solvent dilutions. OPI 220 transfers the series of dilutions to outlet 223 of the transfer conduit 213. If utilized, the ion source device 230 receives the series of dilutions and ionizes samples of the series of dilutions as they are received, producing ion beam 231 that varies as the dilutions are delivered. Ion source device 230 can be an electrospray ion source (ESI) device, for example. Ion source device 230 is shown as part of mass spectrometer 202 in FIG. 2 but may also be a separate device. Mass spectrometer 202 can perform MS or MS/MS. Mass spectrometer 202 may also be any type of mass spectrometer, such as described above in the context of FIG. 1.

The processor 203 is used to send and receive instructions, control signals, and data to and from sample introduction system 201 and MS 202. The processor 203 controls or provides instructions by, for example, controlling one or more voltage, current, or pressure sources (not shown). Processor 203 can be a separate device as shown in FIG. 9 or can be a processor or controller of sample introduction system 201 or mass spectrometer 202 or may be a controller, a computer, a microprocessor, etc. capable of sending and receiving control signals and data and analyzing data.

Note that terms “eject,” “ejection,” “ejection times,” and the like are used throughout this written description in reference to a sample introduction system. One of ordinary skill in the art can appreciate that other terms can also be used to describe the movement of sample from the sample introduction system, such as, but not limited to, terms like “inject,” “injection,” and “injection times.”

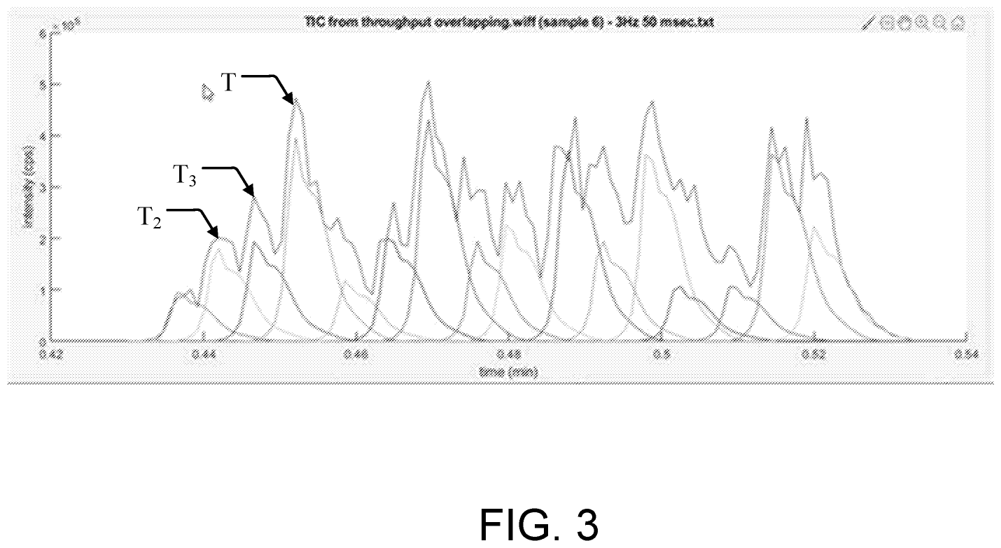

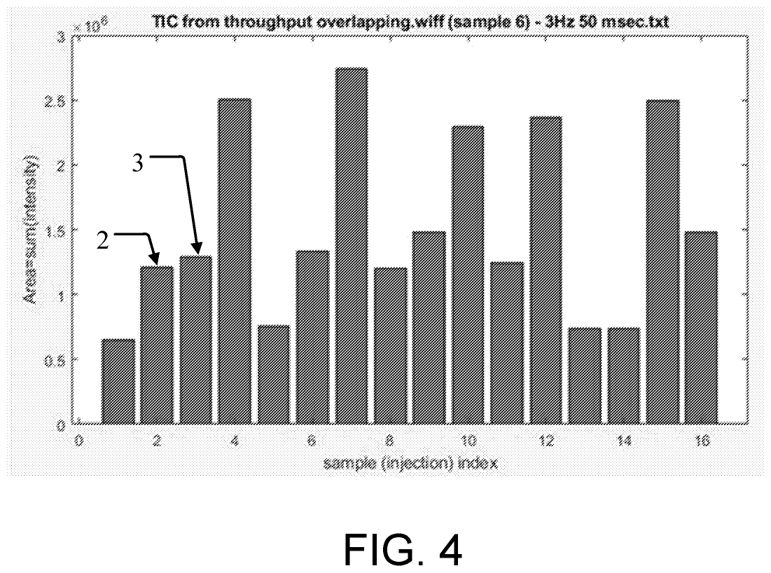

The challenges associated with overlapping signals are depicted in FIG. 3, which illustrates a plot of deconvoluted peaks associated with a plurality of ejections, as well as a merged signal generated by a mass analysis device. The trace T is the merged signal of the data collected by the mass analysis device. The underlying signals associated with each ejection are located below the trace. These underlying signals merge into the trace T, which is displayed on the mass analysis device or an associated computer. As such, determining intensity of each peak located below the trace T is challenging in the absence of the technologies described herein. For example, while the peaks T₂ and T₃ of the trace T are markedly different in height, the underlying peaks from each ejection are nearly identical. This is notable in the context of FIG. 4, which depicts a plot of intensity for each ejection depicted in FIG. 3, as the result of the deconvolutions processes described herein. Note that the intensity of ejections 2 and 3 are nearly identical, which does not correspond at first glance to the peaks T₂ and T₃ of trace T in FIG. 3. The nearly identical intensities of ejections 2 and 3 however, do correspond to the peaks underlying trace peaks T₂ and T₃. The various deconvolution processes described herein enable these accurate determinations of peak intensity, regardless of displayed signal overlap.

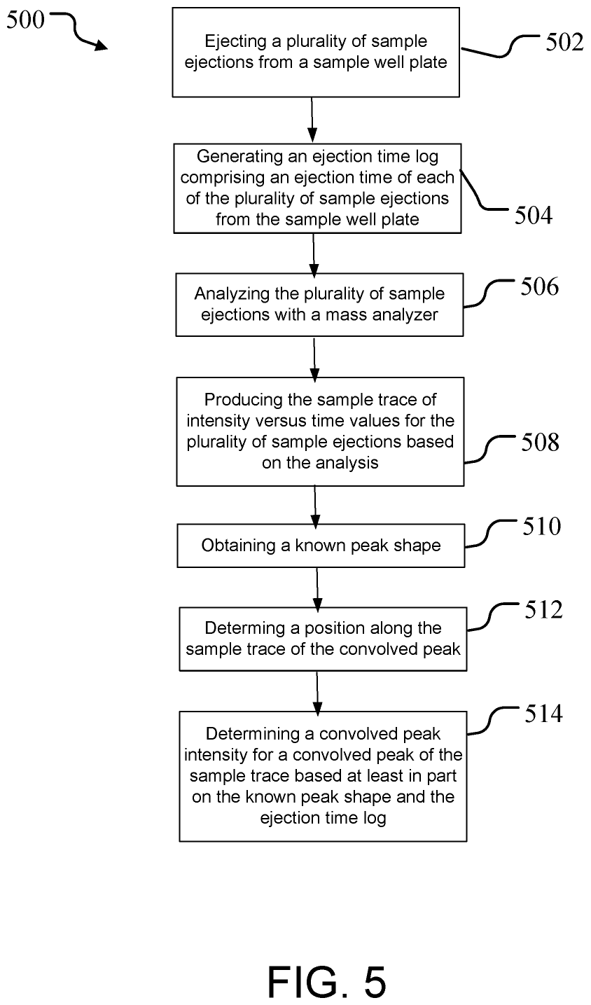

FIG. 5 depicts a method 500 of determining a convolved peak intensity in a sample trace. The method 500 begins with operation 502, ejecting a plurality of sample ejections from a sample well plate. As noted elsewhere herein, the samples may be ejected from one or more sample wells of the sample well plate. Flow continues to operation 504, generating an ejection time log comprising an ejection time of each of the plurality of sample ejections from the sample well plate. The ejection time log may be stored in a memory that may be accessed by a processor or controller. In operation 506, analyzing the plurality of sample ejections with a mass analyzer is performed. Operation 508 includes producing the sample trace of intensity versus time values for the plurality of sample ejections based on the analysis. This may be displayed if desired, which may aid a system user in identifying potential locations of convolved peaks in the trace, note in the trace error conditions, or take other actions, such as troubleshooting, review, or control actions. In operation 510, a known peak shape may be obtained. The specific location of the convolved peak is then determined in operation 512. In operation 514, a convolved peak intensity for a convolved peak of the sample trace may be determined based at least in part on the known peak shape and the ejection time log. Operations 512 and 514 may be performed substantially simultaneously. The method depicted in FIG. 5 is but one example of a method for determining the convolved peak position (within the time scale of the sample trace) and intensity.

In an example of using numerical optimization to determine peak position and intensity, both peak position and intensity are determined simultaneously and the two together define a peak. The peak model has shape parameter(s), position parameter, and intensity parameter. The shape parameter (e.g., the known peak shape) may be obtained from clean peak example or in other ways as described herein. Thereafter, the other two parameters are calculated in order to obtain a measured intensity trace. While peak intensities are independent from each other, peak positions are not; rather, all peaks are spaced consistent with the ejection log-times. However, a precise delay of a peak position (peak model position) with respect to ejection time may not be known. As such, that delay must be determined. Delay is identical or almost identical for all peaks. Optionally, a variation in delay time may be considered, or it may be assumed that delay time is constant. In general, delay could vary for different acquisition parameters, solvent type, “chromatographic system properties”. For given settings mentioned above, individual peak delays are practically identical.

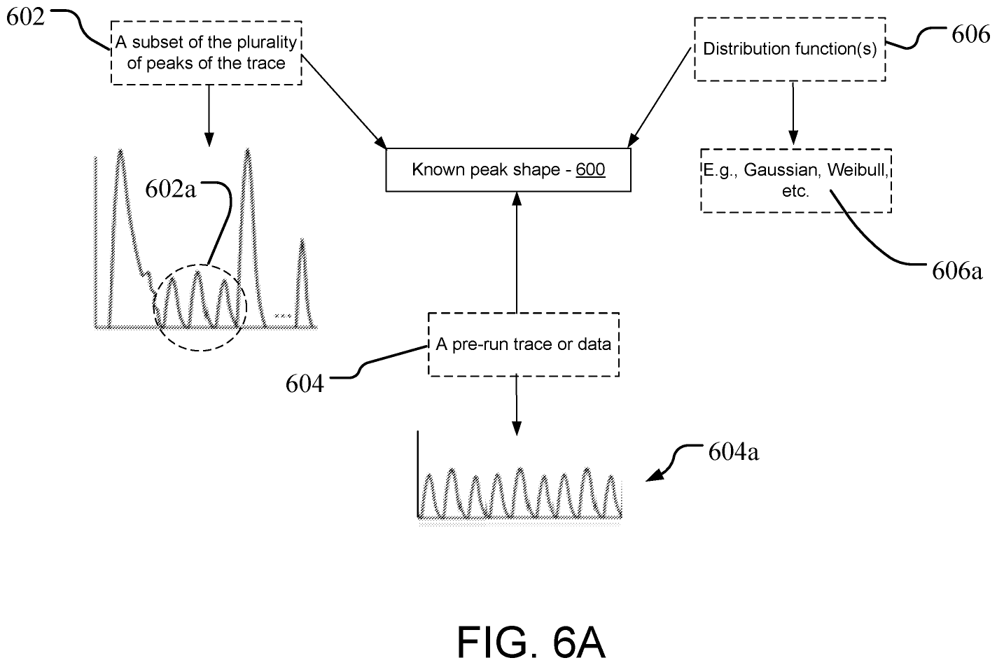

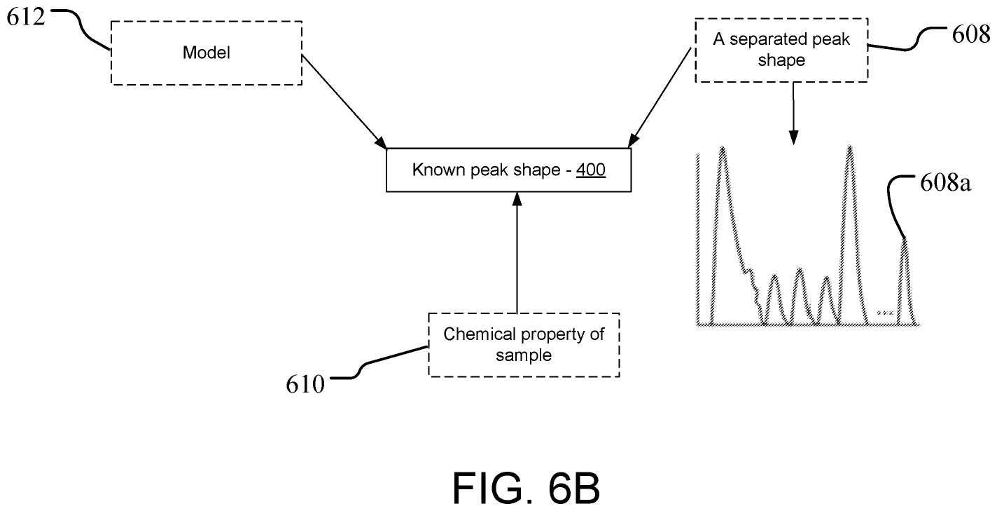

FIGS. 6A-6B depict examples of methods to obtain a known peak shape 600, such as the known peak shape referred to in FIG. 5, in operation 510. The known peak shape 600 may be used to determine an intensity of a convolved peak. In a related aspect, the known peak shape may also be used to estimate a shape of the convolved peak, though this is not necessarily required for all methods. FIG. 6A depicts a first example 602, a subset (e.g., one or more) peaks of the trace may be utilized. In the associated plot depicted in FIG. 6, a subset of peaks 602a in the trace that includes a convolved peak is depicted. This subset of peaks may be averaged, or a known peak shape within a standard deviation of an average or median shape may be utilized. In a second example 604, data, or a trace obtained from such data, of a pre-run may be used to determine the known peak shape. The pre-run 604a is depicted in the associated example plot as including a number of discrete peaks, the shape of which may be readily determined and may be applied as a known peak shape. A third example 606 contemplates fitting one or more distribution functions to the trace, and the resulting fit may be used to determine the known peak shape. The peak shape resulting from application of the distribution function(s) is depicted as a curvature 606a, used to further define the known peak shape.

In FIG. 6B, a separated peak shape may be used in a fourth example 608 to determine the known peak shape. This separated peak shape 608a depicted in the associated plot may result from a discrete, separated ejection of a sample from the sample well plate for any number of reasons, including, but not limited: to system calibration, ejection timer calibration, sample transit time calibration, well plate identification, etc. In a fifth example 610, the known peak shape may be determined or calculated based on a chemical property or other characteristic of a sample in the sample well plate. In a sixth example 612, the known peak shape may be modeled based on some aspect of the system or performance thereof, as described elsewhere herein.

In general, AEMS peak intensity determination is improved by using the ejection timing data provided by the ADE device (e.g., in the ejection time log). Expected AEMS peak times corresponding to the ADE ejection times are calculated using a known delay time from the ejection of a sample to its mass analysis, for example, as the ejected samples transit the transfer conduit towards the mass analysis device. These expected AEMS peak times are then used in one or more of the various examples described herein to determine an intensity of a convolved peak in the AEMS trace. This results in a significant improvement over conventional chromatographic peak integrating algorithms that do not use sample ejection times, since the delay time through a chromatographic column is dependent on the particular sample being analyzed. With the above systems and methods in mind, a number of specific examples follow.

### EXAMPLE 1

In Example 1, peak deconvolution is used to improve quantitative accuracy of small peaks partially overlapped with the tails of larger peaks (e.g., convolved peaks), a situation where conventional area calculation (e.g., by splitting) results in large errors due to a significantly larger peak tail contribution to the smaller peak. This approach requires peaks to be detected first and, in some scenarios, a small peak might be completely convolved (e.g., obscured) by an adjacent larger peak, therefore appearing as a shoulder on the larger peak tail. This results in failure of a peak detector to identify the presence of the convolved peak or the position of the convolved peak. In this example, both presence and position of the convolved peak are desirable for successful peak deconvolution, though only one condition may produce sufficiently accurate results. To overcome this problem, the ejection time may be used that points out the approximate position of all peaks. Peak fitting would further optimize those positions and produce deconvoluted areas.

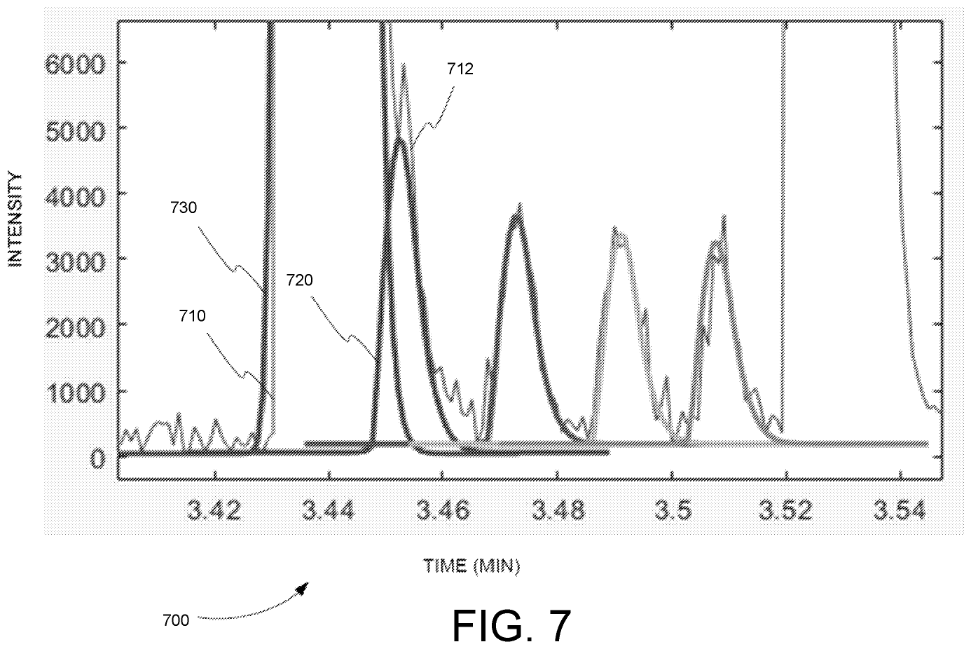

FIG. 7 is a plot of a first example, showing how an AEMS peak area calculation is improved by using the ejection timing data and using at least two different distribution functions. As described above, two different distribution functions can include the use of two functions of the same type, e.g., a Gaussian function, but containing different parameters. Using multiple distributions of the same type of distribution function may require more parameters to adjust, but using at least two different distribution functions of different type, however, can provide the peak shape asymmetry using fewer parameters. In general, an AEMS peak has a stable shape. An AEMS peak has a small peak width variation and a consistent delay with respect to the known ejection or injection time. The coefficient of variation for the area of an AEMS peak is about 3% to about 8%.

In the depicted example, an AEMS peak is first modeled using a peak profile. The AEMS peak profile has an analytical curve or shape able to handle strong rising and long tailing signals. The peak profile is able to handle first derivative singularity points in a numerical optimization. The peak profile is created from an optimum mixture model that deviates from a Gaussian distribution by including at least one additional distribution function. The peak profile is then fitted to the AEMS trace using the ADE ejection times as input to constrain the optimization. The ADE ejection times can also be used to create the peak profile. They can be used to identify an isolated AEMS peak from which the peak profile is created.

FIG. 7 is an exemplary plot 700 showing how an AEMS peak area calculation is improved by using the ejection timing data and using at least two different distribution functions, in accordance with various embodiments. In plot 700, first AEMS peak 710 is a convolved peak, in that a second peak is convolved with peak 710 in trailing edge 712 of peak 710. In order to re-create the second peak, the AEMS peak integrating algorithm creates a peak profile or peak profile model. This peak profile is created by fitting a mixture of a Gaussian distribution function and a Weibull distribution function to an isolated peak (not shown) of the AEMS trace.

In plot 700, the peak profile is fitted to the AEMS trace to create modeled second peak 720. This fitting now uses the known ejection time of the sample producing the second peak. In other words, from the known ejection of the sample producing the second peak, the expected time of the second peak is calculated. The expected time of the second peak is then used to fit the peak profile to the AEMS trace. Modeled second peak 720 is now well-fitted to trailing edge 712 of peak 710.

In other examples, it is contemplated to adjust individual peak times using a constrained time-parameter optimization. In such examples, the optimization of the peak position can be performed since the position is known with a certain precision as there is some randomness in the variation of exact elution time with respect to injection timing (e.g., a parameter that is specifically known). In addition, due to using a Gaussian distribution function and a Weibull distribution function, second peak 720 now has the correct AEMS peak shape. Specifically, second peak 720 now includes a larger gradient for the leading edge than for the trailing edge. Second peak 720 is now an asymmetric peak.

Modeled peak 730 for actual AEMS peak 710 is also improved. The leading edge of modeled peak 730 still includes only a slight deviation from the leading edge of actual peak 710. In addition, this deviation can be compensated for by adjusting the parameters of modeled peak 730. The peak area calculation or integration shown in FIG. 7 is not limited to peaks produced by AEMS. This peak integration can be performed on sample peaks produced by any sample introduction system coupled to a mass spectrometer that produces asymmetric sample mass peaks, records the sample ejection times of the ejections performed by the sample introduction system, and has a consistent delay time from ejection to mass analysis.

### EXAMPLE 2

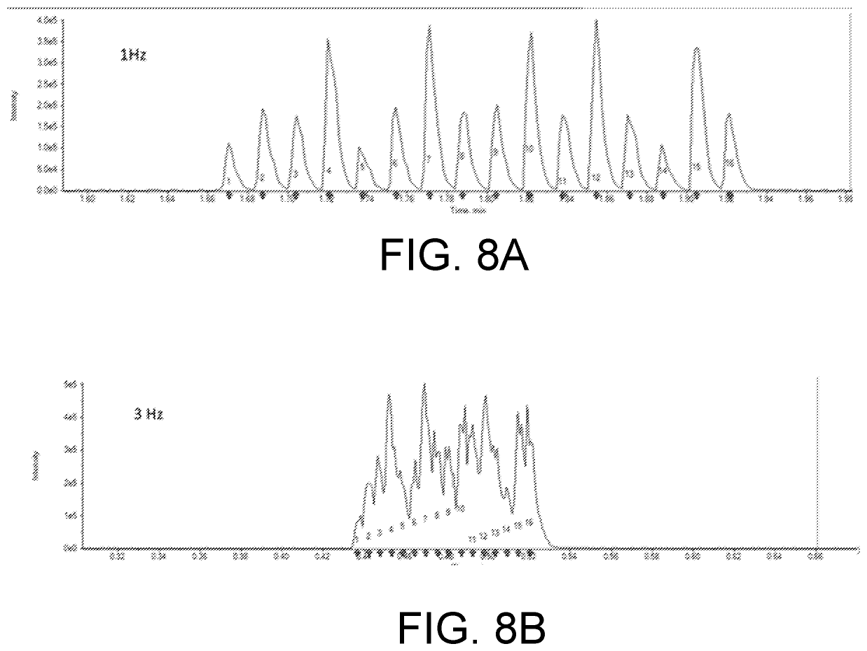

Example 2 deconvolutes the overlapped signal peaks when the delay time between samplings are significantly shorter than the baseline peak-width. In this Example 2, in high throughput acquisition and known sampling rates (constrained by sensitivity and noise), peak overlap is so extensive that the method described in the context of Example 1 cannot be used for a number of reasons. First, peak detection cannot be used since there is not enough discrimination between peak and noise in such high overlap scenario. To illustrate this point, FIG. 8A depicts a sample trace where the samples are ejected at 1 Hz, resulting in discrete, separate peaks the intensity of which is fairly straightforward to calculate. FIG. 8B depicts a sample trace where the samples are ejected at 3 Hz, resulting in significant overlap between adjacent peaks. Because of these significant overlaps, the number of peaks, and approximate position, must be determined in some other way. Fitting large number of peaks to measurement array that is just little bit larger than number of parameters needed to be optimized (for example, each peak is described by 2 parameters; for measurement array may include 70 measurement points across 12 overlapped peaks) results in unstable optimization not reaching global minima of the cost function and incorrect result.

To address the above problems, peak detection is not performed; rather, a peak position initial determination is made based on the ejection time log (end time, for example). The convolved peak must be located between two end times. Using an expected peak profile, more accurate guess of the peak position (e.g., at the apex) is determined. To ensure optimization does not end up at some local minima, additional constraints need to be introduced and/or number of parameters reduced. The number of parameters may be reduced by applying a relative peak distance constraint. Relative distance information may be obtained from the ejection end time log. Since ejection time end is highly correlated with the peak apex position, ejected volume transition through mobile phase is highly reproducible. Ejection time distance between two walls might vary significantly relative to peak width. Using ejection end times, peak positions may be precisely constrained relative to each other and the position the entire set of peaks in time may be optimized, reducing number of parameters by from 2N to N+1. This contributes to numerical optimization stability and more accurate results.

FIG. 9 depicts one example of a suitable operating environment 900 in which one or more of the present examples can be implemented. This operating environment may be incorporated directly into the controller for a mass spectrometry or other mass analysis system, e.g., such as the controller depicted in FIG. 1 or the computer depicted in FIG. 2. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 900 typically includes at least one processing unit 902 and memory 904. Depending on the exact configuration and type of computing device, memory 904 (storing, among other things, instructions to eject samples, create an ejection time log, identify a known peak shape, etc., or perform other methods disclosed herein) can be volatile (such as RAM), non-volatile (such as ROM, flash memory, etc.), or some combination of the two. This most basic configuration is illustrated in FIG. 9 by dashed line 906. Further, environment 900 can also include storage devices (removable, 908, and/or non-removable, 910) including, but not limited to, magnetic or optical disks or tape. Similarly, environment 900 can also have input device(s) 914 such as touch screens, keyboard, mouse, pen, voice input, etc., and/or output device(s) 916 such as a display, speakers, printer, etc. Also included in the environment can be one or more communication connections 912, such as LAN, WAN, point to point, Bluetooth, RF, etc.

Operating environment 900 typically includes at least some form of computer readable media. Computer readable media can be any available media that can be accessed by processing unit 902 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 900 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 900 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 900 is part of a network that stores data in remote storage media for use by the computer system 900.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method for determining a convolved peak intensity in a sample trace, the method comprising:
ejecting a plurality of sample ejections from a sample well plate;
generating an ejection time log comprising an ejection time of each of the plurality of sample ejections from the sample well plate;
analyzing the plurality of sample ejections with a mass analyzer;
producing the sample trace of intensity versus time values for the plurality of sample ejections based on the analysis;
obtaining a known peak shape; and
determining a convolved peak intensity for a convolved peak of the sample trace based at least in part on the known peak shape and the ejection time log.

2. The method of claim 1, further comprising determining a position along the sample trace of the convolved peak.

3. The method of claim 1, further comprising estimating a peak shape of the convolved peak based at least in part on the known peak shape.

4. The method of claim 1, wherein the trace of intensity versus time comprises a plurality of peaks and wherein the known peak shape is based at least in part on a shape of a subset of the plurality of peaks.

5. The method of claim 1, further comprising obtaining pre-run sample data, wherein the pre-run sample data comprises a pre-run sample trace, wherein the known peak shape is based at least in part on the pre-run sample trace.

6. The method of claim 1, further comprising fitting at least one distribution function to the trace, wherein the fitted at least one distribution function comprises the known peak shape.

7. The method of claim 6, wherein the at least one distribution function comprises at least two distribution functions.

8. The method of claim 7, wherein the at least two distribution functions are different.

9. The method of claim 6, wherein the at least two distribution functions comprise a Gaussian distribution function and a Weibull distribution function.

10. The method of claim 1, further comprising detecting a separated peak shape at least one of before and after ejecting the plurality of sample ejections, wherein the known peak shape is based at least in part on the separated peak shape.

11. The method of claim 1, wherein the convolved peak intensity is based at least in part on at least one of a peak area, a peak height, and a peak width.

12. The method of claim 11, wherein the convolved peak intensity is based at least in part on a predetermined percentage of the peak height.

13. The method of claim 11, wherein the convolved peak intensity comprises a peak full-width half-maximum.

14. The method of claim 1, wherein the known peak shape is based at least in part on a chemical property of a sample in the sample well plate.

15. The method of claim 1, wherein the known peak shape is modeled based at least in part on a transport liquid flow rate, a transfer conduit geometry, an open port interface geometry, and a transport liquid property.

16. The method of claim 15, further comprising modeling the known peak shape.

17. A mass analyzer comprising:
a non-contact sample ejector;
a sample receiver adjacent the non-contact sample ejector;
a mass analysis device fluidically coupled to the sample receiver;
a processor operatively coupled to the non-contact sample ejector, the sample receiver, and the mass analysis device; and
memory coupled to the processor, the memory storing instructions that, when executed by the processor, perform a set of operations comprising:
ejecting, with the non-contact sample ejector, a plurality of sample ejections from a sample well plate into the sample receiver;
generating an ejection time log comprising an ejection time of each of the plurality of sample ejections from the sample well plate;
analyzing the plurality of sample ejections with the mass analysis device;
producing a sample trace of intensity versus time values for the plurality of sample ejections based on the analysis;
obtaining a known peak shape; and
determining a convolved peak intensity for a convolved peak of the sample trace based at least in part on the known peak shape and the ejection time log.

18. The mass analyzer of claim 17, further comprising an ionization element, and wherein the set of operations further comprises ionizing the plurality of sample ejections towards the mass analysis device.

19. The mass analyzer of claim 17, wherein the mass analysis device comprises at least one of a differential mobility spectrometer (DMS), a mass spectrometer (MS), and a DMS/MS.

20. The mass analyzer of claim 17, wherein the non-contact sample ejector comprises an acoustic droplet ejector and the sample receiver comprises an open port interface.

21. (canceled)
